(19) United States
(12) Patent Application Publication
(10) Pub. No.: US 2012/0200409 A1
(43) Pub. Date: Aug. 9, 2012

(54) VEHICLE PANIC STOP WARNING METHOD AND APPARATUS

(75) Inventor: John Hill, Marysville, OH (US)

(73) Assignee: Honda Motor Co., Ltd.

(21) Appl. No.: 13/022,114

(22) Filed: Feb. 7, 2011

(51) Int. Cl. B60Q 1/00

(52) U.S. Cl. 340/453

(57) ABSTRACT

Apparatus and methods are presented for generating a vehicle panic stop warning in which the rate of brake pedal translation is determined in a main control unit based on switching state transitions of two or more brake pedal switches and a vehicle horn is actuated based at least partially on the detected rate of brake pedal translation and/or on excessive brake pressure or excessive vehicle deceleration detected by a vehicle stability assist unit.

### BACKGROUND

Modern motor vehicles include rearward facing brake lights operated when the brake pedal is depressed to alert following vehicles that the vehicle is braking. In addition, most vehicles provide an audible horn annunciator mounted in the forward portion of the vehicle and actuated by pressing the center of the steering wheel to other vehicle operators and alert pedestrians to the approaching vehicle. Previously, brake pedal inertia switches and vehicle mounted mercury-switch acceleration sensors or force sensitive resistors have been used to sound a vehicle horn during braking. Other approaches use a magnetic arm mechanically translated by brake pedal actuation through a coil to actuate a warning device through a relay during fast pedal movement. Other techniques include counting pulses generated by a slotted disc to detect sliding/skidding conditions for activating a horn, as well as using a pressure activated switch in the steering wheel to transmit RF warnings to other vehicles upon tight gripping of the steering wheel. During unanticipated emergency stopping situations, the driver often needs to maintain both hands on the steering wheel for maximum vehicle control and may not be able to press the steering wheel horn actuator at all or quickly enough to provide effective warning or a panic stop situation. Thus, there remains a need for improved systems and methods for motor vehicles to warn persons of a nearby vehicle panic stop situation.

### SUMMARY

Various details of the present disclosure are hereinafter summarized to facilitate a basic understanding, where this summary is not an extensive overview of the disclosure, and is intended neither to identify certain elements of the disclosure, nor to delineate the scope thereof. Rather, the primary purpose of this summary is to present some concepts of the disclosure in a simplified form prior to the more detailed description that is presented hereinafter. The present disclosure provides techniques and apparatus for audibly warning nearby vehicle operators and pedestrians of a panic stop situation in which the rate of brake pedal translation is determined using two or more brake pedal switches.

One or more aspects of the disclosure relate to a vehicle panic stop warning apparatus that includes a switching system and a panic stop warning system that determines the rate of brake pedal depression or translation and activates a vehicle horn at least in part according to the detected rate of brake pedal translation. The switching system has first and second switch outputs, each having first and second states, where the second switch state of the first switch output indicates brake pedal translation of at least a first distance and the second state of the second switch output indicates brake pedal translation of at least a greater second distance. The panic stop warning system detects the brake pedal translation rate based at least partially on the switch outputs and selectively initiates actuation of the vehicle horn based at least partially on the detected rate of brake pedal translation.

In certain embodiments, the panic stop detection system actuates the vehicle horn when the temporal (time) difference between transitions of the switch outputs to the second states is less than or equal to a time threshold.

In certain implementations, two separate switches are provided to detect different translation distances of a brake pedal arm structure, and in other embodiments a single switch can be used which provides separate outputs for two depression depths of a switch actuator.

In certain embodiments, the panic stop warning system is implemented in a main integrated control unit (MICU) of the vehicle, which receives the switch outputs and selectively provides a horn actuation output based at least in part on the detected rate of brake pedal translation. The MICU in some embodiments can include a horn actuation input receiving an auxiliary horn actuation signal from a vehicle stability assist (VSA) system, which provide the auxiliary horn actuation signal according to a sensed vehicle operating condition, such as when a change in the brake pressure of the vehicle is greater than or equal to a pressure threshold and the longitudinal vehicle acceleration is below an acceleration threshold.

Further aspects of the disclosure provide a vehicle stability assist system operatively coupled with one or more sensors to detect a vehicle operating condition, where the vehicle stability assist system provides an auxiliary horn actuation signal to actuate a vehicle horn based at least partially on at least one detected vehicle operating condition.

Other aspects of the disclosure provide a method for generating a vehicle panic stop warning. The method includes detecting a rate of brake pedal translation and selectively actuating a vehicle horn based at least partially on the detected rate of brake pedal translation. Certain embodiments of the method further include selectively actuating the vehicle horn when a change in the brake pressure of the vehicle is greater than or equal to a pressure threshold and the a longitudinal acceleration of the vehicle is less than or equal to an acceleration threshold.

### BRIEF DESCRIPTION OF THE DRAWINGS

The following description and drawings set forth certain illustrative implementations of the disclosure in detail, which are indicative of several exemplary ways in which the various principles of the disclosure may be carried out. The illustrated examples, however, are not exhaustive of the many possible embodiments of the disclosure. Other objects, advantages and novel features of the disclosure will be set forth in the following detailed description of the disclosure when considered in conjunction with the drawings, in which:

FIG. 1 is a partial perspective view illustrating an exemplary vehicle panic stop warning apparatus and a vehicle stability assist system for generating a vehicle panic stop warning in accordance with one or more aspects of the present disclosure;

FIGS. 2A-2C are partial sectional side elevation views illustrating an embodiment of a vehicle panic stop warning apparatus switching system including first and second switches to detect the speed of brake pedal translation in a vehicle;

FIGS. 3A-C are partial sectional side elevation views illustrating another switching system embodiment using a single switch to detect brake pedal speed;

FIG. 4 is a flow diagram illustrating an exemplary method of generating a vehicle panic stop warning using brake pedal switch states in accordance with the present disclosure; and

FIG. 5 is a flow diagram illustrating an exemplary method of generating a vehicle panic stop warning according to excessive brake pressure rate change and excessive longitudinal vehicle deceleration in accordance with the disclosure.

### DETAILED DESCRIPTION

One or more embodiments or implementations are hereinafter described in conjunction with the drawings, where like reference numerals are used to refer to like elements throughout, and where the various features are not necessarily drawn to scale.

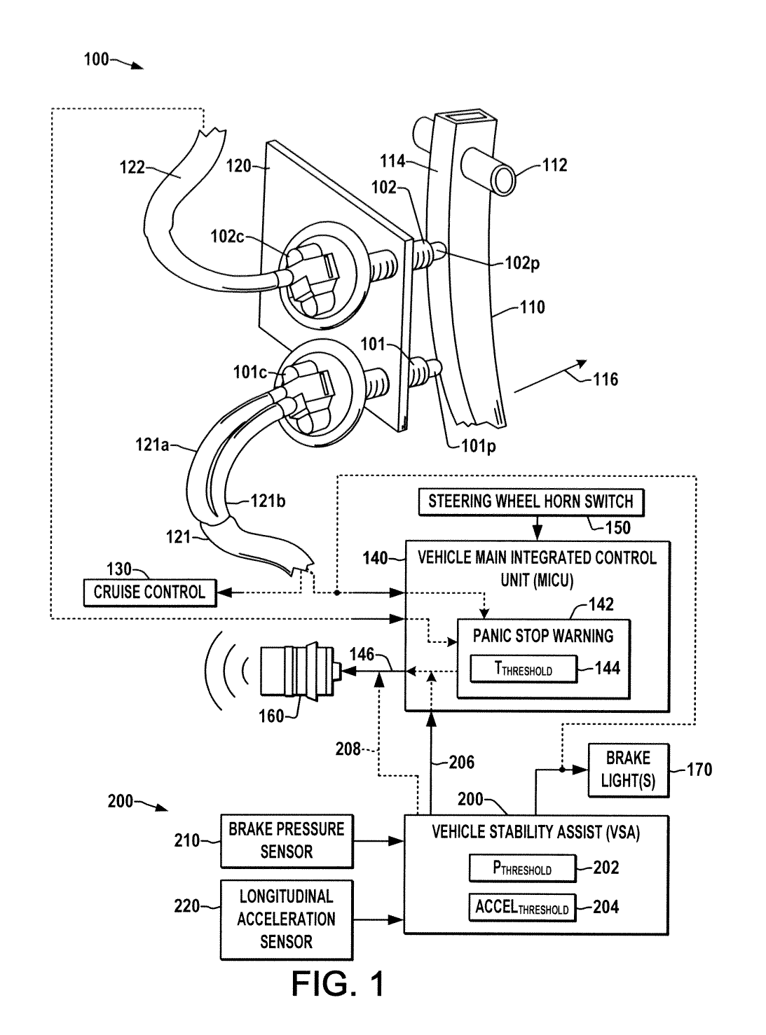

FIG. 1 illustrates an exemplary vehicle panic stop warning apparatus in a motor vehicle which may be used to warn pedestrians or other motorists of a panic stop situation by sounding a vehicle horn or other audible annunciator. In practice, the apparatus may be implemented on any form of motor vehicle, such as cars, trucks, motorcycles, etc., and may advantageously provide audible warnings without the driver having to sacrifice steering control to press a steering wheel/handle bar horn switch 150. This allows the driver/rider to maintain steering control with both hands while controlling the vehicle during emergency/panic stopping situations while providing additional warning to others nearby.

The vehicle in this embodiment includes a switching system 100 with two or more switches associated with a brake pedal, where a portion of a brake pedal arm 110 is illustrated. In this case, the brake pedal arm 110 translates in a first direction 116 as the vehicle operator pushes the brake pedal, with the pedal (not shown) being mounted to a lower end of the arm 110 which pivots about a pivot rod 112 relative to the passenger compartment. Other embodiments are possible in which the brake pedal/arm structure is translatable in linear fashion or other curvilinear fashion wherein all such embodiments are contemplated within the scope of the disclosure. In addition, handlebar mounted brake actuators may be used, and are contemplated as constituting brake pedals and associated translating arm structures as described herein.

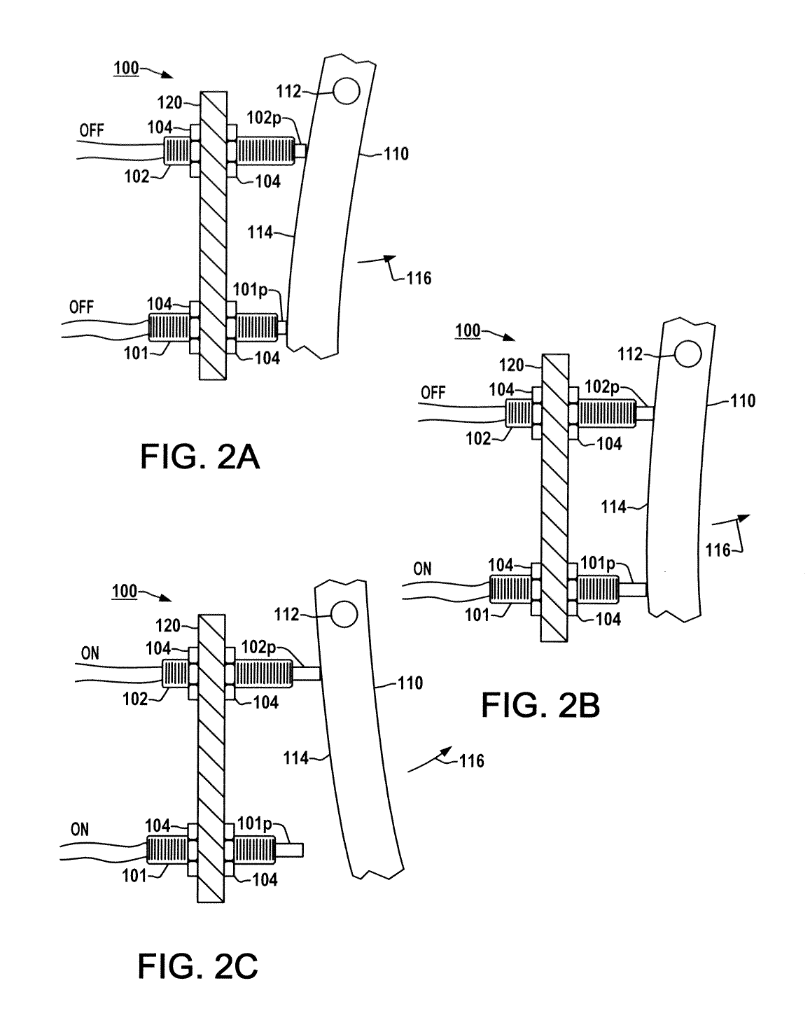

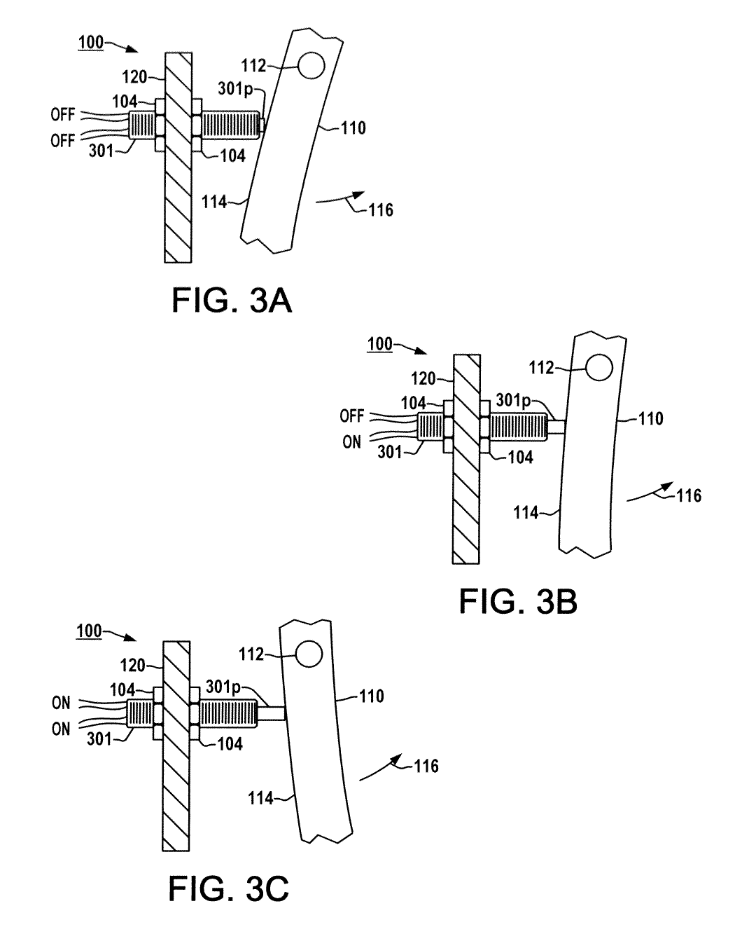

Referring also to FIGS. 2A-2C, the switching system 100 responds to translation of the brake pedal in the stopping direction 116, and provides first and second switch outputs. In the embodiment of FIGS. 1-2C, first and second switching devices 101 and 102 provide the corresponding first and second outputs. Another exemplary embodiment is shown in FIGS. 3A-3C in which a single switching device generates two switch outputs for detection of brake pedal translation speed. In these embodiments, each switch as installed in the vehicle is in a first state (e.g., OFF or open) and a second state (e.g., ON or closed), with the second (ON) state of the first switch output indicating translation of the brake pedal of at least a first distance in the direction 116, and the second (ON) state of the second switch output indicating translation of the brake pedal of at least a second distance in the direction 116, where the second distance is greater than the first distance. Other configurations are possible in which the states are reversed for one or both of the switching devices 101, 102.

As shown in FIGS. 1 and 2A-2C, the first (lower) switch 101 has a threaded cylindrical body with a plunger actuator 101p operative to change the switch 101 from a first state (OFF or open contact) with the plunger 101p depressed along the axis of the cylindrical body to a second state (ON or closed contact) once the plunger 101p has been extended outwardly from the cylindrical body. The cylindrical body of the switch 101 is mounted to a lower hole in a bracket 120 using one or two nuts 104 (FIGS. 2A-2C) allowing adjustment of the axial location of the cylindrical body and thus of the axial positioning of the plunger actuator 101p relative to the bracket 120. In other implementations, the switch 101 could be snap fit with adjustment of the distance on the switch body or key hole. This, in turn, allows adjustment of the actuation point where the output state of the switch 101 transitions from the first state to the second state with respect to the translation of the brake pedal arm 110 along the direction 116. The second switch 102 likewise has a threaded cylindrical body and a plunger actuator 102p to change from a first state with the plunger 102p inwardly depressed to a second state as the plunger 102p is extended outwardly, where the actuation of the plungers 101p and 102p in the illustrated embodiments is done by translation of the brake pedal arm 110 in the direction 116 such that a surface 114 of the arm 110 initially engages and holds the switch actuators 101p, 102p in the depressed positions and then allows these to be outwardly extended as the pedal and arm 110 are translated in the direction 116 (the switch actuators 101p, 102p are internally spring biased in the outward direction such that withdrawal of the arm 110 in the direction 116 results in spring-biased extension of the actuators 101p, 102p outwardly along the cylindrical body axis).

As best seen in FIG. 1, the first switch 101 in one example includes a base to which a locking type connector 101c connects to couple a pair of cables 121a and 121b to the electrical contacts, which may be grouped into a single cable 121 for coupling the contacts with a cruise control system 130 (e.g., for turning off or pausing cruise control operation when the brake pedal is depressed) and to a vehicle main integrated control unit (MICU) 140 as schematically shown in FIG. 1. The second switch 102 provides for connection of its contact terminals to a connector 102c for coupling with a cable 122 providing connection to the MICU 140. The switching system 100 may include more than three switching devices in certain embodiments.

As shown in FIGS. 2A-2C, the switches 101 and 102 are mounted to the bracket 120 such that the first switch 101 is actuated via plunger 101p being engaged and allowed to extend outwardly by the surface 114 of the movement of the brake pedal arm 110 in the braking direction 116 to switch from the first state to the second state before the surface 114 allows extension of the plunger 102p to a state changing position of the second switch 102. In this manner, the vehicle operator may lightly press the brake pedal to thereby actuate the first switch (transitioning the first switch output from the first state to the second state) without necessarily actuating the second switch 102. This is depicted in FIGS. 2A and 2B, where the brake pedal arm 110 begins at a non-braking position shown in FIG. 2A (both switches 101 and 102 having outputs in the first states (OFF, OFF), and the further movement of the arm 110 in the direction 116 causes or allows extension of the first plunger 101p (FIG. 2B) whereupon the first switch output transitions to the second (ON) state while the second switch 102 remains OFF. In this case, the actuation of the first switch 101 will illuminate the rearward facing brake light or lights 170 of the vehicle and the first switch actuation disables or pauses any cruise control system 130 of the vehicle. Referring also to FIG. 2C, if the driver depresses the brake pedal further in the direction 116, the plunger actuator 102p of the second switch 102 is allowed to be further extended so as to transition the second switch 102 to the second state (ON).

The switch contact outputs of the switching devices 101 and 102 are operatively coupled as inputs to the MICU 140, which includes a panic stop warning system 142. The MICU 140 and the warning system 142 thereof can be implemented as hardware, processor-executed software, processor-executed software, programmable logic, etc., or combinations thereof, where the MICU 140 in one embodiment includes a processing component and associated memory programmed to implement general vehicle control functions as well as the panic stop warning functionality of the present disclosure. In particular, the panic stop warning system 142 receives the switch states of the switches 101 and 102 and detects a rate of brake pedal translation based in whole or in part on the at least two switch outputs of the switching system 100. The exemplary warning system 142 is further operative to selectively initiate actuation of a vehicle horn 160 at least partially according to the detected rate of brake pedal translation. The warning system 142 may determine a braking pedal translation rate according to the switching state information using any suitable algorithm or technique. In certain embodiments, the panic stop detection system 142 time stamps the switching state transitions of the switches 101 and 102 from their first states to their second states and records the corresponding transition times as T1 and T2, respectively. The system 142 then computes a time (temporal) difference T2−T1 between transitions of the first and second switch outputs to the respective second states and compares this time difference T2−T1 with a time threshold T_{THRESHOLD} 144 (FIG. 1). In this manner, quick brake pedal depressions that are forceful enough to actuate the second switch 102 will be detected and identified as panic stop situations by the system 142. This approach will also selectively refrain from horn actuation if the transition to the second switch states is slow or gradual, and also if the vehicle operator does not press the brake pedal far enough to actuate the second switch 102. If T2−T1 is less than or equal to the threshold T_{THRESHOLD}, the panic stop warning system 142 of the MICU 140 selectively provides a horn actuation output 146 to the vehicle horn 160 to alert nearby persons and animals that the vehicle is in a panic stop situation, and the vehicle horn is activated without requiring the driver to press the steering wheel horn switch 150.

In the embodiment of FIG. 1, moreover, the MICU 140 also includes a horn actuation input for receiving an auxiliary horn actuation signal 206 from a vehicle stability assist (VSA) system 200. In this case, the MICU 140 selectively provides the horn actuation output 146 to the vehicle horn 160 based at least partially on the auxiliary horn actuation signal 206, regardless of whether the panic stop warning system generates a panic stop determination and/or whether the operator presses the steering wheel horn switch. The VSA system 200 can be implemented as hardware, processor-executed software, processor-executed software, programmable logic, etc., or combinations thereof, programmed, configured, or otherwise operable to perform one or more stability monitoring and control functions. In addition, the VSA system 200 is operatively coupled with one or more sensors, such as a brake pressure sensor 210, a longitudinal acceleration sensor (accelerometer) 220, etc., and operates to detect one or more vehicle operating conditions for vehicle stability control and to selectively actuate the vehicle horn 160, either through the MICU 140 via signal 206 and/or by directly providing an actuating signal 208 to the horn 160 as shown in FIG. 1. The VSA system 200 in certain embodiments provides an auxiliary horn actuation signal 206 or 208 to actuate a vehicle horn 160 based at least partially on a detected vehicle operating condition. For instance, the exemplary system 200 provides the auxiliary horn actuation signal 206 or 208 to a horn actuation when a rate of increased brake pressure of the vehicle is greater than or equal to a pressure threshold P_{THRESHOLD} 202 and when a longitudinal acceleration of the vehicle is less than an acceleration threshold ACCEL_{THRESHOLD} 204 thus indicating rapid braking (quick deceleration). In certain implementations, the VSA system 200 may be operative to selectively activate the horn 160 when the brake pressure demand rate exceeds the threshold P_{THRESHOLD} 202 over a predetermined time range and excessive longitudinal deceleration is sensed.

FIGS. 3A-3C illustrate another embodiment in which the switching system 100 includes a switching device 301 providing the first and second switch outputs. In this case, the switch 301 includes a single actuator 301p facing the surface 114 of the brake pedal arm 110. The plunger actuator 301p is operated by engagement and depression via the arm 110 to change the first switch output from the first state to the second state when translation of the brake pedal arm 110 in the direction 116 causes the surface 114 to depress the actuator 301p by a first amount as shown in FIGS. 3A and 3B. Further brake pedal translation in the direction 116 as shown in FIG. 3C causes the second switch output to change from its first state to the second state when translation of the brake pedal arm 110 depresses the actuator 301p by a second amount, where the second amount is greater than the first amount. In this manner, the panic stop warning system 142 can distinguish light braking from aggressing braking based on the switch state transitions in a manner similar to that described above in connection with FIGS. 2A-2C.

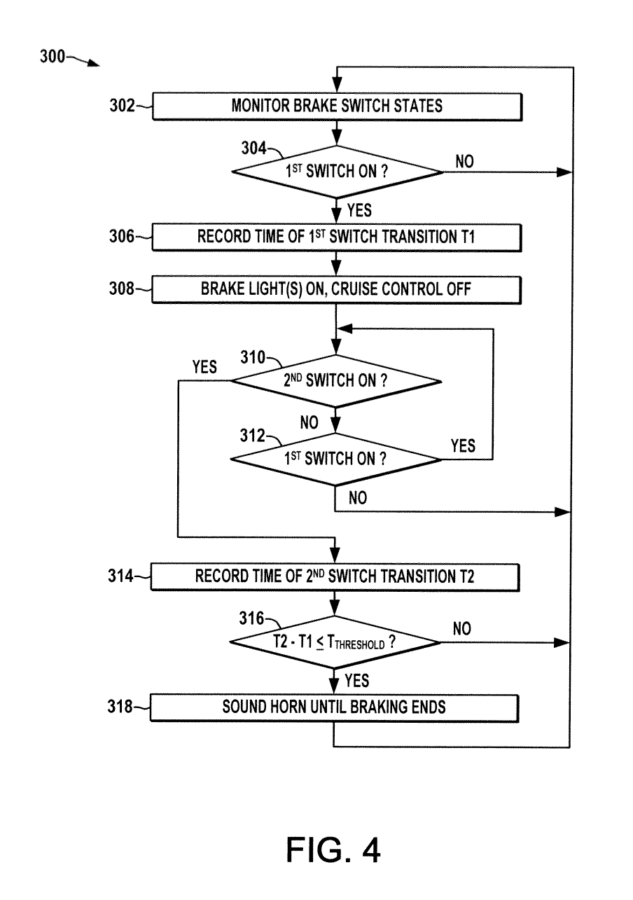

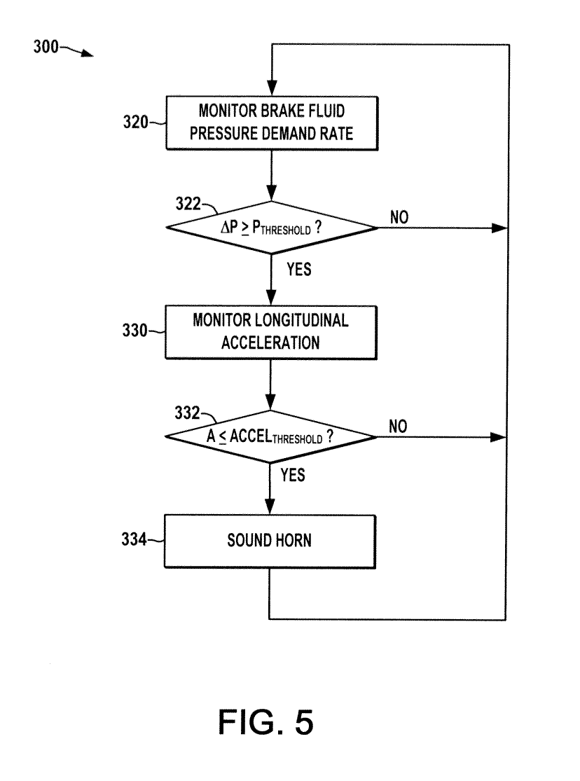

Referring also to FIGS. 4 and 5, an exemplary method 300 is illustrated for generating a vehicle panic stop warning. Although the exemplary method 300 and other disclosed methods are illustrated and described as a series of acts or events, it will be appreciated that the various methods are not limited by the illustrated ordering of such acts or events except as specifically set forth herein. In this regard, except as specifically provided hereinafter, some acts or events may occur in different order and/or concurrently with other acts or events apart from those illustrated and described herein, and not all illustrated steps may be required to implement a process or method in accordance with the present disclosure. The illustrated method 300 and other methods of the disclosure, moreover, may be implemented in any suitable hardware, processor-executed software/firmware, or combinations thereof, in order to provide vehicle panic stop warnings.

Beginning at 302, the method 300 includes monitoring the switching states of the brake switches (e.g., switches 101, 102, 301 of the switching system 100) and detecting a rate of brake pedal translation at 304-314. The method 300 further includes selectively actuating a vehicle horn (e.g., horn 160 above) at 316 based at least partially on the detected rate of brake pedal translation. In the illustrated embodiment, a determination is made at 304 as to whether the first switch is ON, and if not, the monitoring continues at 302. Once the first switch is actuated (YES at 304), the time of its actuation (T1) is recorded at 306, which may cause activation of one or more brake lights (e.g., brake light(s) 170 in FIG. 1 above) and deactivation or pausing of a cruise control feature (e.g., cruise control 130 above) at 308. A determination is made at 310 as to whether the second switch is ON (second switch 102 or a second switch output transition in the combined switch 301 above). If not (NO at 310), a determination is made at 312 as to whether the first switch remains on, and if not (NO at 312), the process returns to 302 as described above). If the first switch remains ON (“YES at 312), the process again checks the second switch state at 310. If the second switch is turned ON (YES at 310), the state transition time T2 of the second switch output is recorded at 314 and a determination is made at 316 as to whether the first and second switch state transitions occurred within a predetermined threshold time value (whether T2−T1≦T_{THRESHOLD}). If not (NO at 316), the process returns to switch state monitoring at 302 as previously described. However, if the switch transitions were sufficiently close in time (YES at 316 with T2−T1≦T_{THRESHOLD}), the vehicle horn is activated at 318 to sound until the braking ends (e.g., until the switches return to the OFF state) or for some other duration or until a different termination condition occurs, and the process 300 returns to 302.

As shown in FIG. 5, the process 300 may further include selectively actuating the vehicle horn 160 when a change in the brake pressure (ΔP) of the vehicle is greater than or equal to a pressure threshold P_{THRESHOLD} and the acceleration of the vehicle is less than an acceleration threshold ACCEL_{THRESHOLD}. This operation may be undertaken concurrently with (e.g., independently from) the braking pedal translation speed-based panic stop determination described in FIG. 4, where the horn may be sounded for either of these conditions. At 320 in FIG. 5, the brake fluid pressure demand rate is monitored, and a determination is made at 322 as to whether the change in the monitored pressure equals or exceeds a threshold (ΔP≧P_{THRESHOLD}). If not (NO at 322), the monitoring continues at 320, and if so (YES at 322) the

the process 300 proceeds to check the longitudinal acceleration at 330, and a determination is made at 332 as to whether the monitored acceleration (A) is less than or equal to an acceleration threshold (e.g., whether A≦ACCEL_{THRESHOLD}). If not (NO at 332), the monitoring continues at 320 as described above. If the acceleration is sufficiently low (deceleration, YES at 332), the horn is sounded at 334. This further acceleration-based operation may be undertaken concurrently with (e.g., independently from) the braking pedal translation speed-based panic stop determination described in FIG. 4.

The above examples are merely illustrative of several possible embodiments of various aspects of the present disclosure, wherein equivalent alterations and/or modifications will occur to others skilled in the art upon reading and understanding this specification and the annexed drawings. In particular regard to the various functions performed by the above described components (assemblies, devices, systems, and the like), the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the illustrated implementations of the disclosure. In addition, although a particular feature of the disclosure may have been illustrated and/or described with respect to only one of several implementations, such feature may be combined with one or more other features of the other implementations as may be desired and advantageous for any given or particular application. Also, to the extent that the terms “including”, “includes”, “having”, “has”, “with”, or variants thereof are used in the detailed description and/or in the claims, such terms are intended to be inclusive in a manner similar to the term “comprising”.

The following is claimed:

1. A vehicle panic stop warning apparatus, comprising:
a switching system associated with a brake pedal and operatively responsive to translation of the brake pedal, the switching system comprising first and second switch outputs, each switch output having a first state and a second state, the second state of the first switch output indicating translation of the brake pedal of at least a first distance in a first direction, and the second state of the second switch output indicating translation of the brake pedal of at least a second distance in the first direction, the second distance being greater than the first distance; and
a panic stop warning system operative to detect a rate of brake pedal translation based at least partially on the at least two switch outputs of the switching system and to selectively initiate actuation of a vehicle horn based at least partially on the detected rate of brake pedal translation.

2. The apparatus of claim 1, where the panic stop detection system is operative to initiate actuation of the vehicle horn when a temporal difference between transitions of the first and second switch outputs to the respective second states is less than or equal to a time threshold.

3. The apparatus of claim 2, where the switching system comprises:
a first switching device providing the first switch output, the first switching device comprising an actuator facing a surface of a brake pedal arm, the actuator of the first switching device operative to change the first switch output from the first state to the second state when translation of the brake pedal arm in the first direction causes the surface to depress the actuator of the first switching device; and
a second switching device providing the second switch output, the second switching device comprising an actuator facing the surface of the brake pedal arm, the actuator of the second switching device operative to change the second switch output from the first state to the second state when translation of the brake pedal arm in the first direction causes the surface to depress the actuator of the second switching device.

4. The apparatus of claim 2, where the switching system comprises a switching device providing the first and second switch outputs, the switching device comprising an actuator facing a surface of a brake pedal arm, the actuator operative to change the first switch output from the first state to the second state when translation of the brake pedal arm in the first direction causes the surface to depress the actuator by a first amount, and to change the second switch output from the first state to the second state when translation of the brake pedal arm in the first direction causes the surface to depress the actuator by a second amount, the second amount being greater than the first amount.

5. The apparatus of claim 2, where the panic stop warning system is implemented in a main integrated control unit, where the main integrated control unit is operatively coupled with the switching system to receive the at least two switch outputs and to selectively provide a horn actuation output to the vehicle horn when the temporal difference between transitions of the first and second switch outputs to the respective second states is less than or equal to the time threshold.

6. The apparatus of claim 5, where the main integrated control unit further comprises a horn actuation input receiving an auxiliary horn actuation signal from a vehicle stability assist system, where the main integrated control unit is further operable to selectively provide the horn actuation output to the vehicle horn based at least partially on the auxiliary horn actuation signal.

7. The apparatus of claim 6, where the vehicle stability assist system is operable to provide the auxiliary horn actuation signal to cause the main integrated control unit to provide the horn actuation output to the vehicle horn when a change in a brake pressure of the vehicle is greater than or equal to a pressure rate threshold and a longitudinal acceleration of the vehicle is less than or equal to an acceleration threshold.

8. The apparatus of claim 1, where the panic stop warning system is implemented in a main integrated control unit, where the main integrated control unit is operatively coupled with the switching system to receive the at least two switch outputs and to selectively provide a horn actuation output to the vehicle horn based at least partially on the detected rate of brake pedal translation when the switch outputs are both in the second state, where the main integrated control unit comprises a horn actuation input receiving an auxiliary horn actuation signal from a vehicle stability assist system, and where the main integrated control unit is further operable to selectively provide the horn actuation output to the vehicle horn based at least partially on the auxiliary horn actuation signal.

9. The apparatus of claim 8, where the vehicle stability assist system is operable to provide the auxiliary horn actuation signal to cause the main integrated control unit to provide the horn actuation output to the vehicle horn when a change in a brake pressure of the vehicle is greater than or equal to a pressure rate threshold and a longitudinal acceleration of the vehicle is less than or equal to an acceleration threshold.

10. A vehicle stability assist system operatively coupled with at least one sensor to detect at least one vehicle operating condition, the vehicle stability assist system being operable to provide an auxiliary horn actuation signal to actuate a vehicle horn based at least partially on at least one detected vehicle operating condition.

11. The vehicle stability assist system of claim 10, where the vehicle stability assist system is operable to provide the auxiliary horn actuation signal to cause a main integrated control unit to provide a horn actuation output to the vehicle horn based at least partially on at least one detected vehicle operating condition.

12. The vehicle stability assist system of claim 11, where the vehicle stability assist system is operable to provide the auxiliary horn actuation signal to cause the main integrated control unit to provide the horn actuation output to the vehicle horn when a change in a brake pressure of the vehicle is greater than or equal to a pressure rate threshold and a longitudinal acceleration of the vehicle is less than or equal to an acceleration threshold.

13. The vehicle stability assist system of claim 10, where the vehicle stability assist system is operable to provide the auxiliary horn actuation signal to cause the main integrated control unit to provide the horn actuation output to the vehicle horn when a change in a brake pressure of the vehicle is greater than or equal to a pressure rate threshold and a longitudinal acceleration of the vehicle is less than or equal to an acceleration threshold.

14. A method for generating a vehicle panic stop warning, the method comprising:
detecting a rate of brake pedal translation; and
selectively actuating a vehicle horn based at least partially on the detected rate of brake pedal translation.

15. The method of claim 14, further comprising selectively actuating the vehicle horn when a change in brake pressure of the vehicle is greater than or equal to a pressure threshold and a longitudinal acceleration of the vehicle is less than or equal to an acceleration threshold
